(19) United States
(12) Patent Application Publication
(10) Pub. No.: US 2003/0166488 A1
(43) Pub. Date: Sep. 4, 2003

(54) Dishwashing and cleaning compositions

(76) Inventors: Michael Elsner, Heiligenhaus (DE); Manfred Weuthen, Langenfeld (DE)

Correspondence Address: COGNIS CORPORATION, 2500 RENAISSANCE BLVD., SUITE 200, GULPH MILLS, PA, 19406

(21) Appl. No.: 10/317,343

(22) Filed: Dec. 10, 2002

(30) Foreign Application Priority Data
Dec. 19, 2001 (DE) 101 62 696.7

(51) Int. Cl. C11D 17/00

(52) U.S. Cl. 510/421

(57) ABSTRACT

A dishwashing and cleaning composition comprising: (a) from about 0.01 to about 25% by weight of a hydroxy mixed ether of the formula (I):

R¹O[CH₂CHR⁴O]ₓ[CH₂CHR³O]_{y}CH₂CH(OH)R² (I)

wherein each of R¹ and R² is independently an alkyl and/or alkenyl group having from 4 to 22 carbon atoms, each of R³ and R⁴ is independently hydrogen or a methyl group, each of x and y independently has a value of from 0 to 40, with the proviso that x+y≧1; (b) from about 0.1 to about 20% by weight of an anionic surfactant selected from the group consisting of an alkyl and/or alkenyl sulfate, an alkyl ether sulfate, an alkyl benzene sulfonate and an alkane sulfonate. The compositions according to the invention exhibit good foaming and cleaning behavior, more particularly very good drainage behavior on plastic surfaces, and high material compatibility with the surfaces to be cleaned.

### CROSS-REFERENCE TO RELATED APPLICATIONS

This application claims priority of German patent application number 101 62 696.7, filed on Dec. 19, 2001.

### BACKGROUND OF THE INVENTION

This invention relates to dishwashing and cleaning compositions containing a combination of hydroxy mixed ethers and selected anionic surfactants, optionally other nonionic surfactants and to the use of such mixtures in dishwashing and cleaning compositions.

Compositions for the washing and cleaning of hard non-textile surfaces occurring in the home and in the institutional sector are generally intended to generate little foam in use, the foam they do generate being expected to collapse significantly in a few minutes. Compositions of this type are well-known and established on the market. They are essentially aqueous surfactant solutions of various kinds with and without added builders, solubilizers (hydrotropes) or solvents. Although the consumer prefers the in-use solution to foam to a certain extent at the beginning of the cleaning task as proof of effectiveness, the foam is expected to collapse rapidly so that cleaned surfaces do not have to be rewiped. To this end, low-foaming nonionic surfactants are normally added to compositions of the type mentioned.

Today, machine-washed tableware has to meet stricter requirements than hand-washed tableware. Thus, even tableware completely free from food residues is regarded as unsatisfactory when, after dishwashing, it still has whitish stains which are attributable to water hardness or other mineral salts and which come from water droplets that have remained on the tableware through lack of wetting agent and dried.

Accordingly, to obtain bright, spotless tableware, rinse agents have to be used. The addition of liquid or solid rinse agent—which may be separately added or which is already present in ready-to-use form together with the detergent and/or regenerating salt (“2-in-1”, “3-in-1”, for example in the form of tablets and powders)—ensures that the water drains completely from the tableware so that the various surfaces are bright and free from residues at the end of the dishwashing program.

Commercially available rinse agents are mixtures of, for example, nonionic surfactants, solubilizers, organic acids and solvents, water and optionally preservative and perfumes.

The function of the surfactants in these compositions is to influence the interfacial tension of the water in such a way that it is able to drain from the tableware as a thin, coherent film so that no droplets of water, streaks or films remain behind during the subsequent drying process (so-called wetting effect). Accordingly, another function of surfactants in rinse agents is to suppress the foam generated by food residues in the dishwashing machine. Since the rinse agents generally contain acids to improve the clear drying effect, the surfactants used also have to be relatively hydrolysis-resistant towards acids.

Rinse agents are used both in the home and in the institutional sector. In domestic dishwashers, the rinse agent is added after the prerinse and wash cycle at 40 to 65° C. Institutional dishwashers use only one wash liquor which is merely replenished by addition of the rinse agent solution from the preceding wash cycle. Accordingly, there is no complete replacement of water in the entire dishwashing program. Because of this, the rinse agent is also expected to have a foam-suppressing effect, to be temperature-stable in the event of a marked drop in temperature from 85 to 35° C. and, in addition, to be satisfactorily resistant to alkali and active chlorine.

DE-A1 19738866 describes surfactant mixtures of hydroxy mixed ethers and nonionic surfactants, such as optionally end-capped fatty alcohol polyethylene glycol/polypropylene glycol ethers, which have very good foaming behavior and show excellent clear rinse effects in rinse agents.

It is known from German Offenlegungsschrift DE-OS 2432757 that hydroxy mixed ethers can be used as foam suppressors in laundry detergents, dishwashing detergents and cleaning compositions.

The problem addressed by the present invention was to provide dishwashing and cleaning compositions which, at one and the same time, would show good foaming and cleaning behavior, more particularly very good drainage behavior on plastic surfaces, and high material compatibility of the surfaces to be cleaned. In addition, the invention sought to provide hydroxy mixed ether mixtures which could be incorporated with particular advantage in solid formulations.

The problem stated above has been solved by the use of hydroxy mixed ethers in combination with selected anionic surfactants.

By virtue of its relatively high melting points, this combination of hydroxy mixed ethers and selected anionic surfactants dissolves in the cleaning liquor at a relatively late stage and develops its effect with delay and in relatively high concentrations. This effect can be utilized with particular advantage in rinse agent applications. The mixtures according to the invention are surprisingly distinguished above all by their clear colorless appearance which enables them to be incorporated in a number of dishwashing/cleaning compositions without having to be subjected to expensive bleaching beforehand.

### BRIEF SUMMARY OF THE INVENTION

The present invention pertains to a dishwashing and cleaning composition comprising: (a) from about 0.01 to about 25% by weight of a hydroxy mixed ether of the formula (I):

R¹O[CH₂CHR⁴O]ₓ[CH₂CHR³O]_{y}CH₂CH(OH)R² (I)

wherein each of R¹ and R² is independently an alkyl and/or alkenyl group having from 4 to 22 carbon atoms, each of R³ and R⁴ is independently hydrogen or a methyl group, each of x and y independently has a value of from 0 to 40, with the proviso that x+y≧1; (b) from about 0.1 to about 20% by weight of an anionic surfactant selected from the group consisting of an alkyl and/or alkenyl sulfate, an alkyl ether sulfate, an alkyl benzene sulfonate and an alkane sulfonate. The compositions according to the invention exhibit good foaming and cleaning behavior, more particularly very good drainage behavior on plastic surfaces, and high material compatibility with the surfaces to be cleaned.

### BRIEF DESCRIPTION OF THE SEVERAL VIEWS OF THE DRAWING

Not applicable.

### DETAILED DESCRIPTION OF THE INVENTION

Hydroxy mixed ethers corresponding to formula (I) are known from the literature and are described, for example, in German patent application DE 19738866. They are prepared by reaction of 1,2-epoxyalkanes (R²CHOCH₂), where R² is an alkyl and/or alkenyl group containing 2 to 22 and more particularly 6 to 16 carbon atoms, with alkoxylated alcohols. Hydroxy mixed ethers preferred for the purposes of the invention are those derived from alkoxylates of monohydric C₄₋₁₈ alcohols with the formula R¹—OH, R¹ being an aliphatic, saturated, linear or branched alkyl group, more particularly containing 6 to 16 carbon atoms. Examples of suitable straight-chain alcohols are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, palmityl alcohol, heptadecan-1-ol, stearyl alcohol, nonadecan-1-ol, arachidyl alcohol, heneicosan-1-ol, behenyl alcohol and the technical mixtures thereof obtained in the high-pressure hydrogenation of technical methyl esters based on fats and oils. Examples of branched alcohols are so-called oxo alcohols which generally contain 2 to 4 methyl groups as branches and are produced by the oxo process and so-called Guerbet alcohols which are branched in the 2-position by an alkyl group. Suitable Guerbet alcohols are 2-ethyl hexanol, 2-butyl octanol, 2-hexyl decanol and/or 2-octyl dodecanol.

The alcohols are used in the form of their alkoxylates which are prepared in known manner by reaction of the alcohols with ethylene oxide and/or propylene oxide. Alkoxylates of alcohols formed by reaction with 1 to 80 mol ethylene oxide (R⁴ and R³=hydrogen and x+y=1-80) are preferably used. Alkoxylates formed by reaction of alcohol with 1 to 10 mol propylene oxide (R⁴=methyl, x=1-10) and then with 10 to 80 mol ethylene oxide (R³=hydrogen, y=10-80) and also by reaction with 10 to 80 mol ethylene oxide (R⁴=hydrogen, x=10-80) and with with 1 to 10 mol propylene oxide (R³=methyl, y=1-10) are preferred. In this case, the alkylene units are present in “blocked” form.

However, hydroxy mixed ethers in which the alkylene units, preferably ethylene oxide and propylene oxide, are “randomized” (x=1-40, y=1-40 and R³=R⁴), i.e. hydroxy mixed ethers in which the alkylene units are statistically distributed are obtained by the preliminary mixing of the alkoxylating agents, are also particularly preferred.

Hydroxy mixed ethers which contain randomized ethylene oxide and propylene oxide units in a ratio of 40:1 to 40:5 are particularly preferred.

Hydroxy mixed ethers with a narrow distribution of the alkylene units (narrow range hydroxy mixed ethers) are most particularly preferred.

Dishwashing/cleaning preparations which have proved to be particularly suitable from the performance perspective preferably contain hydroxy mixed ethers corresponding to formula (I) in which

[symbol] R¹ is a linear alkyl group containing 8 to 10 carbon atoms, R³ is hydrogen, R⁴ is a methyl group and R² is a linear alkyl group containing 8 to 10 carbon atoms, x is a number of 0.5 to 2 and y is a number of 20 to 40, for example the commercial products DEHYPON® 3447 and DEHYPON® 3557 of Cognis Deutschland GmbH;

[symbol] R² is a linear alkyl group containing 8 to 10 carbon atoms, R¹ is a branched alkyl group containing 8 to 10 carbon atoms, R³ is hydrogen, x=0 and y=20 to 40;

[symbol] R¹ is a linear alkyl group containing 8 to 10 carbon atoms, R³ is hydrogen, R² is a linear alkyl group containing 8 to 10 carbon atoms, x=0 and y=40 to 60.

The dishwashing/cleaning compositions according to the invention contain from about 0.01 to about 25% by weight, preferably from about 0.025 to 20% by weight and more particularly from about 0.1 to about 15% by weight of hydroxy mixed ethers corresponding to formula (I), expressed as active substance and based on the composition.

Active substance is defined as the weight of surfactants (expressed as 100% pure material) present in the dishwashing/cleaning composition.

According to the invention, the dishwashing/cleaning compositions contain anionic surfactants.

Anionic Surfactants

Typical examples of anionic surfactants are soaps, alkyl benzenesulfonates, secondary alkane sulfonates, olefin sulfonates, alkyl ether sulfonates, glycerol ether sulfonates, α-methyl ester sulfonates, sulfofatty acids, alkyl and/or alkenyl sulfates, alkyl ether sulfates, glycerol ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, protein fatty acid condensates (particularly wheat-based vegetable products) and alkyl (ether) phosphates. If the anionic surfactants contain polyglycol ether chains, the polyglycol ether chains may have a conventional homolog distribution, although they preferably have a narrow homolog distribution.

The combination according to the invention of hydroxy mixed ethers with anionic surfactants selected from the group consisting of alkyl and/or alkenyl sulfates, alkyl ether sulfates, alkyl benzenesulfonates and alkanesulfonates, more particularly fatty alcohol sulfates, fatty alcohol ether sulfates, secondary alkanesulfonates and linear alkyl benzenesulfonates is preferred.

Alkyl and/or Alkenyl Sulfates

Alkyl and/or alkenyl sulfates, which are often also referred to as fatty alcohol sulfates, are understood to be the sulfation products of primary alcohols which correspond to formula (II):

R¹⁶O—SO₃X (II)

in which R¹⁶ is a linear or branched, aliphatic alkyl and/or alkenyl group containing 6 to 22 carbon atoms and preferably 12 to 18 carbon atoms and X is an alkali metal and/or alkaline earth metal, ammonium, alkyl ammonium, alkanolammonium or glucammonium. Typical examples of alkyl sulfates which may be used in accordance with the invention are the sulfation products of caproic alcohol, caprylic alcohol, capric alcohol, 2-ethyl hexyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol and the technical mixtures thereof obtained by high-pressure hydrogenation of technical methyl ester fractions or aldehydes from Roelen's oxo synthesis. The sulfation products may advantageously be used in the form of their alkali metal salts and particularly their sodium salts. Alkyl sulfates based on vegetable C_{12/14} fatty alcohols in the form of their sodium salts are particularly preferred.

Alkyl Ether Sulfates

Alkyl ether sulfates (“ether sulfates”) are known anionic surfactants which, on an industrial scale, are produced by SO₃ or chlorosulfonic acid (CSA) sulfation of fatty alcohol or oxoalcohol polyglycol ethers and subsequent neutralization. Ether sulfates suitable for use in accordance with the invention correspond to formula (III):

R¹⁷O—(CH₂CH₂O)ₐSO₃X (III)

in which R¹⁷ is a linear or branched alkyl and/or alkenyl group containing 6 to 22 carbon atoms, a is a number of 1 to 10 and X is an alkali metal and/or alkaline earth metal, ammonium, alkylammonium, alkanolammonium or glucammonium. Typical examples are the sulfates of addition products of on average 1 to 10 and more particularly 2 to 5 mol ethylene oxide onto caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and technical mixtures thereof in the form of their sodium and/or magnesium salts. The ether sulfates may have both a conventional homolog distribution and a narrow homolog distribution. It is particularly preferred to use ether sulfates based on adducts of on average 2 to 3 mol ethylene oxide with technical C_{12/14} or C_{12/18} coconut fatty alcohol fractions in the form of their sodium and/or magnesium salts.

Alkyl Benzenesulfonates

Alkyl benzenesulfonates preferably correspond to formula (IV):

R¹⁸—Ph—SO₃X (IV)

in which R¹⁸ is a branched, but preferably linear alkyl group containing 10 to 18 carbon atoms, Ph is a phenyl group and X is an alkali metal and/or alkaline earth metal, ammonium, alkyl ammonium, alkanolammonium or glucammonium. Dodecyl benzenesulfonates, tetradecyl benzenesulfonates, hexadecyl benzenesulfonates and technical mixtures thereof in the form of the sodium salts are preferably used.

Alkanesulfonates

Alkanesulfonates are understood to be compounds corresponding to formula (V):

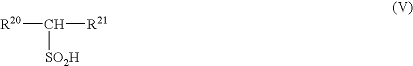

where R²⁰ and R²¹ are alkyl groups, with the proviso that R²⁰ and R²¹ together contain no more than 50 carbon atoms. Alkane sulfonates with C₁₃₋₁₇ carbon chains (R²⁻+R²¹=C₁₃₋₁₇) are particularly preferred.

The dishwashing/cleaning compositions contain 0.1 to 20% by weight, preferably 0.25 to 15% by weight and more particularly 0.4 to 10% by weight anionic surfactants, expressed as active substance and based on the composition. The balance to 100% by weight of the cleaning/dishwashing compositions may be made up by auxiliaries and water.

Nonionic Surfactants

In a preferred embodiment, the compositions according to the invention contain other nonionic surfactants. Typical examples of nonionic surfactants are alkyl and/or alkenyl oligoglycosides, alkoxylates of alkanols, end-capped alkoxylates of alkanols with no free OH groups, alkoxylated fatty acid lower alkyl esters, amine oxides, alkylphenol polyglycol ethers, fatty acid polyglycol esters, fatty acid amide polyglycol ethers, fatty amine polyglycol ethers, alkoxylated triglycerides, mixed ethers and mixed formals, fatty acid-N-alkyl glucamides, protein hydrolyzates (more particularly wheat-based vegetable products), polyol fatty acid esters, sugar esters, sorbitan esters and polysorbates. If the nonionic surfactants contain polyglycol ether chains, they may have a conventional homolog distribution although they preferably have a narrow homolog distribution.

The other nonionic surfactants are preferably selected from the group consisting of alkyl and/or alkenyl oligoglycosides, alkoxylates of alkanols, more particularly fatty alcohol polyethylene glycol/polypropylene glycol ethers (FAEO/PO) or fatty alcohol polypropylene glycol/polyethylene glycol ethers (FAPO/EO), end-capped alkoxylates of alkanols with no free OH group, more particularly end-capped fatty alcohol polyethylene glycol/polypropylene glycol ethers or end-capped fatty alcohol polypropylene glycol/polyethylene glycol ethers, and fatty acid lower alkyl esters and amine oxides.

Alkyl and/or Alkenyl Oligoglycosides

The dishwashing/cleaning compositions according to the invention contain alkyl and/or alkenyl oligoglycosides corresponding to formula (VI):

R⁵O—[G]ₚ (VI)

These may be obtained by the relevant methods of preparative organic chemistry. The synoptic articles by Biermann et al. in Starch/Stärke 45, 281 (1993), B. Salka in Cosm. Toil. 108, 89 (1993) and J. Kähre et al. in SÖFW-Journal, No. 8, 598 (1995) are cited as representative of the extensive literature available on the subject.

The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides.

The alkyl group R⁵ may be derived from primary saturated alcohols. Typical examples are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, cetyl alcohol, palmityl alcohol, heptadecan-1-ol, stearyl alcohol, isostearyl alcohol, nonadecan-1-ol, arachidyl alcohol, heneicosan-1-ol and behenyl alcohol and the technical mixtures thereof obtained, for example, in the hydrogenation of technical fatty acid methyl esters or in the hydrogenation of aldehydes from Roelen's oxo synthesis.

The alkenyl group R⁵ may be derived from primary unsaturated alcohols. Typical examples of unsaturated alcohols are undecen-1-ol, oleyl alcohol, elaidyl alcohol, ricinolyl alcohol, linoleyl alcohol, linolenyl alcohol, gadoleyl alcohol, arachidonyl alcohol, erucyl alcohol, brassidyl alcohol, palmitoleyl alcohol, petroselinyl alcohol, arachyl alcohol and the technical mixtures thereof obtainable in the manner described above. Alkyl or alkenyl groups R⁵ derived from primary C₆₋₁₆ alcohols are preferred.

Alkyl oligoglucosides having a chain length of C₈ to C₁₀, which are obtained as first runnings in the separation of technical C₈₋₁₈ coconut fatty alcohol by distillation and which may contain less than 6% by weight of C₁₂ alcohol as an impurity, and also alkyl oligoglucosides based on technical C_{9/11} oxoalcohols are preferred. In addition, the alkyl or alkenyl group R⁵ may also be derived from primary alcohols containing 12 to 14 carbon atoms.

The index p in general formula (VI) indicates the degree of oligomerization (DP), i.e. the distribution of mono- and oligoglycosides, and is a number of 1 to 10. Whereas p in a given compound must always be an integer and, above all, may assume a value of 1 to 3, the value p for a certain alkyl oligoglycoside is an analytically determined calculated quantity which is generally a broken number.

Alkyl and/or alkenyl oligoglycosides having an average degree of oligomerization p of 1.1 to 2.0 are preferably used. Alkyl and/or alkenyl oligoglycosides having a degree of oligomerization of less than 2.0 and, more particularly, between 1.2 and 1.7 are preferred from the applicational point of view.

Alkyl and/or alkenyl oligoglycosides corresponding to formula (II), where p is a number of 1 to 3 and R⁵ is a C₆₋₁₆ alkyl group, are preferably used.

The dishwashing/cleaning compositions according to the invention preferably contain from about 0.01 to about 30% by weight, preferably from about 0.1 to about 20% by weight and more particularly from about 0.2 to about 15% by weight of alkyl and/or alkenyl oligoglycosides corresponding to formula (VI), expressed as active substance and based on the composition.

Fatty Alcohol Polyethylene Glycol/Polypropylene Glycol Ethers

A preferred embodiment is characterized by the use of optionally end-capped fatty alcohol polyethylene glycol/polypropylene glycol ethers corresponding to formula (VII):

R⁶O(CH₂CH₂O)ₙ[CH₂(CH₃)CHO]ₘR⁷ (VII)

in which R⁶ is an alkyl and/or alkenyl group containing 8 to 22 carbon atoms, R⁷ is H or an alkyl group containing 1 to 8 carbon atoms, n is a number of 1 to 40, preferably 1 to 30 and more particularly 1 to 15 and m is 0 or a number of 1 to 10.

Fatty Alcohol Polypropylene Glycol/Polyethylene Glycol Ethers

Optionally end-capped fatty alcohol polypropylene glycol/polyethylene glycol ethers corresponding to formula (VIII):

R⁸O[CH₂(CH₃)CHO]q(CH₂CH₂O)ᵣR⁹ (VIII)

in which R⁸ is an alkyl and/or alkenyl group containing 8 to 22 carbon atoms, R⁹ is H or an alkyl group containing 1 to 8 carbon atoms, q is a number of 1 to 5 and r is a number of 0 to 15, are also suitable.

In a preferred embodiment, the compositions according to the invention contain fatty alcohol polyethylene glycol/polypropylene glycol ethers corresponding to formula (VII) in which R⁶ is an aliphatic saturated, linear or branched alkyl group containing 8 to 16 carbon atoms, n is a number of 1 to 10, m is 0 and R⁷ is hydrogen. These compounds (VII) are products of the addition of 1 to 10 mol ethylene oxide onto monohydric alcohols. Suitable alcohols are the above-described alcohols, such as fatty alcohols, oxo alcohols and Guerbet alcohols. Other suitable alcohol ethoxylates are those which have a narrow homolog distribution.

Other suitable representatives of non-end-capped representatives are those corresponding to formula (VII) in which R⁶ is an aliphatic, saturated, linear or branched alkyl group containing 8 to 16 carbon atoms, n is a number of 2 to 7, m is a number of 3 to 7 and R⁷ is hydrogen. These compounds (VII) are products of the addition of monohydric alcohols of the type already described alkoxylated first with 2 to 7 mol ethylene oxide and then with 3 to 7 mol propylene oxide.

The end-capped compounds of formula (VII) are terminated by a C₁₋₈ alkyl group (R⁷). In the literature, such compounds are also commonly referred to as mixed ethers. Suitable representatives are methyl-group-terminated compounds of formula (VII) in which R⁶ is an aliphatic, saturated, linear or branched alkyl group containing 8 to 16 carbon atoms, n is a number of 2 to 7, m is a number of 3 to 7 and R⁷ is a methyl group. Compounds such as these may readily be prepared by reacting the corresponding non-end-capped fatty alcohol polyethylene glycol/polypropylene glycol ethers with methyl chloride in the presence of a base.

Suitable representatives of alkyl-group-terminated compounds are those of formula (VII), in which R⁶ is an aliphatic, saturated, linear or branched alkyl group containing 8 to 16 carbon atoms, n is a number of 5 to 15, m is 0 and R⁷ is an alkyl group containing 4 to 8 carbon atoms. The end capping is preferably carried out with a linear or branched butyl group by reacting the corresponding fatty alcohol polyethylene glycol ether with n-butyl chloride or with tert.butyl chloride in the presence of bases.

Optionally end-capped fatty alcohol polypropylene glycol/polyethylene glycol ethers of formula (VIII) may be present instead of or in admixture with the compounds of formula (III). Compounds such as these are described, for example, in DE-A1-43 23 252. Particularly preferred representatives of the compounds of formula (VIII) are those in which R⁸ is an aliphatic, saturated, linear or branched alkyl group containing 8 to 16 carbon atoms, q is a number of 1 to 5, r is a number of 1 to 6 and R⁹ is hydrogen. Compounds such as these are preferably products of the addition of 1 to 5 mol propylene oxide and 1 to 6 mol ethylene oxide onto monohydric alcohols which have already been described as suitable in connection with the hydroxy mixed ethers.

Alkoxylated Fatty Acid Lower Alkyl Esters

Suitable alkoxylated fatty acid lower alkyl esters are surfactants corresponding to formula (IX):

R¹⁰OC—(OCH₂CHR¹¹)_{w}OR¹² (IX)

in which R¹⁰CO is a linear or branched, saturated and/or unsaturated acyl group containing 6 to 22 carbon atoms, R¹¹ is hydrogen or methyl, R¹² represents linear or branched alkyl groups containing 1 to 4 carbon atoms and w is a number of 1 to 20. Typical examples are the formal insertion products of on average 1 to 20 and preferably 5 to 10 mol ethylene and/or propylene oxide into the methyl, ethyl, propyl, isopropyl, butyl and tert.butyl esters of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Normally, the products are obtained by insertion of the alkoxides into the carbonyl ester bond in the presence of special catalysts such as, for example, calcined hydrotalcite. Reaction products of on average 5 to 10 mol ethylene oxide into the ester bond of technical coconut fatty acid methyl esters are particularly preferred.

Amine Oxides

Compounds corresponding to formula (X) and/or (XI):

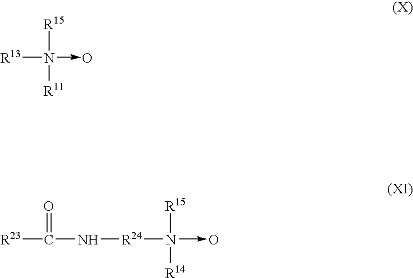

may be used as amine oxides. The amine oxides corresponding to formula (X) are produced by oxidation of tertiary fatty amines having an least one long alkyl chain in the presence of hydrogen peroxide. In the amine oxides of formula (X) suitable for the purposes of the invention, R¹³ is a linear or branched alkyl chain containing 6 to 22 and preferably 12 to 18 carbon atoms and R¹⁴ and R¹⁵ independently of one another have the same meaning as R¹³ or represent an optionally hydroxysubstituted alkyl group containing 1 to 4 carbon atoms. Preferred amine oxides of formula (X) are those in which R¹³ and R¹⁴ represent C_{12/14} or C_{12/18} coconut alkyl groups and R¹⁵ is a methyl or hydroxyethyl group. Other preferred amine oxides of formula (X) are those in which R¹³ is a C_{12/14} or C_{12/18} coconut alkyl group and R¹⁴ and R¹⁵ represent a methyl or hydroxyethyl group. Other suitable amine oxides are alkylamidoamine oxides corresponding to formula (XI) where the alkylamido group R²³CONH is formed by the reaction of linear or branched carboxylic acids preferably containing 6 to 22 and more particularly 12 to 18 carbon atoms, more particularly from C_{12/14} or C_{12/18} fatty acids, with amines. R²⁴ is a linear or branched alkenyl group containing 2 to 6 and preferably 2 to 4 carbon atoms and R¹⁴ and R¹⁵ are as defined for formula (X).

The other nonionic surfactants may be present in the compositions according to the invention in quantities of from about 0.1 to about 15% by weight, preferably from about 0.5 to about 0% by weight and more particularly from about 1 to about 8% by weight, expressed as active substance and based on the composition.

The compositions according to the invention may contain, for example, solubilizers, such as cumenesulfonate, ethanol, isopropyl alcohol, ethylene glycol, propylene glycol, butyl glycol, diethylene glycol, propylene glycol monobutyl ether, polyethylene or polypropylene glycol ether with molecular weights of 600 to 1,500,000 and preferably in the range from 400,000 to 800,000 or, more particularly, butyl diglycol as auxiliaries. Abrasives, such as silica flour or wood flour or polyethylene friction elements, may also be present. In many cases, an additional bactericidal effect is required so that the compositions may contain cationic surfactants or biocides, for example glucoprotamine.

Suitable builders are zeolites, layer silicates, phosphates and ethylenediamine tetraacetic acid, nitrilotriacetic acid, citric acid and salts thereof and inorganic phosphonic acids.

Among the compounds acting as peroxy bleaching agents, sodium perborate tetrahydrate and sodium perborate monohydrate are particularly important. Other bleaching agents are, for example, peroxycarbonate, citrate perhydrates and H₂O₂-yielding peracidic salts of the per acids, such as perbenzoates, peroxyphthalates or diperoxydodecanedioic acid. They are normally used in quantities of from about 0.1 to about 40% by weight. Sodium perborate monohydrate in quantities of from about 10 to about 20% by weight and more particularly from about 10 to about 15% by weight is preferably used.

Suitable enzymes are those from the class of proteases, lipases, amylases, cellulases or mixtures thereof. Enzymes obtained from bacterial strains or fungi, such as Bacillus subtilis, Bacillus licheniformis and Streptomyces griseus are particularly suitable. Proteases of the subtilisin type, particularly proteases obtained from Bacillus lentus, are preferably used. The percentage content of enzymes may be from about 0.1 to 6% by weight and is preferably from 0.2 to 2% by weight. The enzymes may be adsorbed onto carriers or encapsulated in membrane materials to protect them against premature decomposition.

In addition to mono- and polyhydric alcohols and phosphonates, the compositions may contain other enzyme stabilizers. For example, from about 0.5 to about 1% by weight sodium formate may be used. Proteases stabilized with soluble calcium salts which have a calcium content of preferably about 1.2% by weight, based on the enzyme, may also be used. However, it is of particular advantage to use boron compounds, for example boric acid, boron oxide, borax and other alkali metal borates, such as the salts of orthoboric acid (H₃BO₃), metaboric acid (HBO₂) and pyroboric acid (tetraboric acid H₂B₄O₇).

Where the compositions are used in machine cleaning processes, it can be of advantage to add typical foam inhibitors to them. Suitable foam inhibitors contain, for example, known organopolysiloxanes and/or paraffins or waxes. The compositions may also contain foam regulators, for example soap, fatty acids, more particularly coconut oil fatty acid and palm kernel oil fatty acid.

Suitable thickeners are, for example, hydrogenated castor oil, salts of long-chain fatty acids which are preferably used in quantities of 0 to 5% by weight and more particularly in quantities of from about 0.5 to about 2% by weight, for example sodium, potassium, aluminum, magnesium and titanium stearates or the sodium and/or potassium salts of behenic acid and other polymeric compounds. These other polymeric compounds are preferably polyvinyl pyrrolidone, urethanes and the salts of polymeric polycarboxylates, for example homopolymeric or copolymeric polyacrylates, polymethacrylates and in particular copolymers of acrylic acid with maleic acid, preferably those of 50 to 10% by weight maleic acid. The relative molecular weight of the homopolymers is generally in the range from about 1,000 to about 100,000 and that of the copolymers in the range from about 2,000 to about 200,000 and preferably in the range from 50,000 to about 120,000, based on the free acid. Water-soluble polyacrylates crosslinked, for example, with about 1% of a polyallyl ether of sucrose and having a molecular weight above 1,000,000 are also particularly suitable. Examples include the polymers obtainable under the name of Carbopol® 940 and 941. The crosslinked polyacrylates are preferably used in quantities of not more than about 1% by weight and more particularly in quantities of from about 0.2 to about 0.7% by weight.

The present invention also relates to the use of hydroxy mixed ethers for washing and cleaning hard surfaces, preferably in the home and in the industrial and institutional sectors. The hydroxy mixed ethers are particularly suitable for use in dishwashing detergents, rinse agents, bathroom cleaners, floor cleaners, so-called clean shower cleaners (for example bathroom cleaners which are sprayed onto walls and fittings before and after showering so that the water and soap residues drain off better so that no wiping is necessary), cockpit cleaners (cars, aircraft, ships, motorbikes), window cleaners and all-purpose cleaners. Hard surfaces are inter alia ceramic surfaces, metal surfaces, painted surfaces, plastic surfaces and surfaces of glass, stone, concrete, china and wood.

The use of the hydroxy mixed ethers (a) according to the invention and anionic surfactants (b) is particularly preferred for washing and cleaning hard surfaces, more particularly in dishwasher detergents and/or rinse agents, which then show particularly high compatibility with plastics and very good drainage behaviour.

In another preferred embodiment, the hydroxy mixed ethers (a) and anionic surfactants (b) are used in combination with alkyl and/or alkenyl oligoglycosides in the cleaning sectors mentioned in the foregoing.

The combination according to the invention of hydroxy mixed ethers (a) and anionic surfactants (b), optionally in conjunction with the other surfactants already described, is most particularly preferred for the production of solid cleaners.

### EXAMPLES

Method for Evaluating the Wetting Properties of Surfactant Solutions on Plastics

The wetting properties of surfactant solutions on plastics were determined in a test under the conditions/test parameters in a commercially available dishwasher, but without actually using one. To evaluate the wetting properties, plastic test specimens measuring 20×5×0.4 cm are cleaned first with 1% NaOH and then with isopropanol. The test specimens thus pretreated are then immersed in the solution to be tested and immediately withdrawn again. Evaluation is carried out visually by drawing up a ranking list or on a scoring scale of 1 to 5 where a score of 5 means that the liquid film breaks up spontaneously and the wetting effect is completely eliminated. A score of 5 is obtained where water is used. A score of 1 signifies complete wetting of the plastic surface and uniform drainage of the liquid film. A score of 1 is obtained where Na-LAS (for example MARANIL® A55 (COGNIS) is used.

| Test Parameters: | |
|---|---|
| Water hardness: | 2° d |
| Salt content: | 700 ppm |
| Temperature: | 60° C. |
| Surfactant concentration: | 0.05% (active substance) |

TABLE 1

| Active | | | | | | | | | | | | | | | | |
|---|---|---|---|---|---|---|---|---|---|---|---|---|---|---|---|---|
| sub- | | | | | | | | | | | | | | | | |
| stance | C1 | C2 | C3 | C4 | 1 | 2 | 3 | 4 | 5 | 6 | 7 | 8 | 9 | 10 | 11 | 12 |
| HME I | | 15.0 | | | 13.0 | 13.0 | 13.0 | 13.0 | | | | | | | | |
| HME II | | | 15.0 | | | | | | 13.0 | 13.0 | 13.0 | 13.0 | | | | |
| HME III | | | | 15.0 | | | | | | | | | 11.0 | 11.0 | 11.0 | 11.0 |
| LABS (Na | | | | | 3.6 | | | | 3.6 | | | | 7.5 | | | |
| salt) | | | | | | | | | | | | | | | | |
| FAS | | | | | | 2.0 | | | | 2.0 | | | | 4.0 | | |
| FAES | | | | | | | 2.9 | | | | 2.9 | | | | 5.7 | |
| SAS | | | | | | | | 3.3 | | | | 3.3 | | | | 6.7 |
| Cumene- | 3.0 | 3.0 | 3.0 | 3.0 | 3.0 | 5.0 | 5.0 | 3.0 | 3.0 | 5.0 | 5.0 | 3.0 | 3.0 | 5.0 | 5.0 | 3.0 |
| sulfonate | | | | | | | | | | | | | | | | |
| Citric acid | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 |
| Deionized | to 100 | | | | | | | | | | | | | | | |
| water | | | | | | | | | | | | | | | | |
| Appear- | Clear | Clear | | | Clear | Clear | Clear | Clear | | | | | | | | |
| ance at | | | | | | | | | | | | | | | | |
| 70° C. | | | | | | | | | | | | | | | | |
| Wetting | | | | | | | | | | | | | | | | |
| properties | | | | | | | | | | | | | | | | |
| on plastics | | | | | | | | | | | | | | | | |
| Polypro- | 5 | 3 | 3 | 3 | 2 | 2 | 2 | 1 | 2 | 3 | 2 | 2 | 1 | 2 | 1 | 2 |
| pylene | | | | | | | | | | | | | | | | |
| Poly- | 5 | 3 | 3 | 3 | 2 | 2 | 2 | 2 | 2 | 2 | 2 | 2 | 1 | 2 | 2 | 2 |
| ethylene | | | | | | | | | | | | | | | | |
| Poly- | 5 | 2 | 3 | 3 | 2 | 2 | 1 | 1 | 2 | 2 | 2 | 3 | 2 | 1 | 1 | 1 |
| carbonate | | | | | | | | | | | | | | | | |

HME I: linear C₈₋₁₀ fatty alcohol + 1PO + 22EO-2-hydroxydecyl ether
HME II: branched C₁₀ fatty alcohol + 22EO-2-hydroxydecyl ether
HME III: linear C₈₋₁₀ fatty alcohol + 40EO-2-hydroxydodecyl ether
LABS: linear alkyl benzenesulfonate, sodium dodecyl benzenesulfonate, MARANIL ® A 55 (Cognis)
FAS: C₁₂₋₁₄ fatty alcohol sulfate, SULFOPON ® 1214G (Cognis)
FAES: fatty alcohol ether sulfate, sodium lauryl ether sulfate + 2EO, TEXAPON ® N 70 (Cognis)
SAS: secondary C_{13-17 alkane sulfonate, HOSTAPUR ® SAS 60}

In Table 1, Examples C1 and C4 are Comparison Examples while Examples 1 to 12 are the Examples according to the invention.

Evaluation of the Shine of Washed Tableware

The test described below was used for subjectively visually evaluating the tableware for shine.

First, dishwasher tablets containing rinse agent were made from the compositions according to the invention (1 to 3, see Tables 2-5) and placed in the dishwasher.

The dishwasher used was a Miele G 661 SC with the “Universal 50/55°” cleaning program. The water hardness was ca. 20° dH.

The dishwasher was loaded with 20 glasses, 20 black china plates, 20 blue PP bowls and 20 pieces of cutlery. 50 g of minced meat (pork:beef 1:1) containing 2 g fat was seared and mixed with a gravy of 100 ml water, 1 g gravy binder and 2.5 g instant gravy powder to form the test soil. The test soil was placed in a basket in the dishwasher.

The shine was visually evaluated after the entire wash cycle had been repeated 5 times by directly comparing the five different test loads. Evaluation (score 1=best performance, score 5=worst performance) was carried out by five people independently of one another. The average value is shown in Tables 2 to 5. Formulations C1 and C2 are intended for comparison while formulations 1 to 3 represent the formulations according to the invention.

It can be seen that the formulations according to the invention produce the best evaluation.

TABLE 2

| | [% by weight] | | | | |
|---|---|---|---|---|---|
| | C1 | C2 | 1 | 2 | 3 |
| STPP (sodium tripolyphosphate) | 35 | 35 | 35 | 35 | 35 |
| Sodium carbonate (anhydrous) | 7 | 7 | 7 | 7 | 7 |
| Na silicate, amorphous (5iO₂:Na₂O = 2) | 20 | 20 | 20 | 20 | 20 |
| Protease/amylase | 1.8 | 1.8 | 1.8 | 1.8 | 1.8 |
| Na perborate monohydrate/tetrahydrate | 8 | 8 | 8 | 8 | 8 |
| DEHYPON ® LS 54 (fatty alcohol | 10 | — | — | — | — |
| polyglycol ether) | | | | | |
| HME I | — | 10 | 8 | | |
| HME II | | | | 8 | |
| HME III | | | | | 8 |
| LABS (Na salt) | — | — | 3.6 | 3.6 | 3.6 |
| TAED | 3 | 3 | 3 | 3 | 3 |
| Ethane-1-hydroxy-1, 1-diphosphonic acid | 2 | 2 | 2 | 2 | 2 |
| (HEDP) | | | | | |
| Paraffin/emulsifier | 10 | 8 | 8 | 7 | 8 |
| Polyacrylic acid (MW = 8,000) | 2 | 2 | 2 | 2 | 2 |
| Sodium sulfate | to 100 | to 100 | to 100 | to 100 | to 100 |
| Evaluation of shine | | | | | |
| China | 4.8 | 3.4 | 2.2 | 2.2 | 2.4 |
| Glass | 4.8 | 3.6 | 2.0 | 2.0 | 2.6 |
| Cutlery | 4.0 | 3.4 | 2.4 | 2.4 | 2.8 |
| Polypropylene | 5.0 | 3.8 | 2.4 | 1.6 | 2.2 |

Abbreviations in Tables 2-5:
HME I: linear C₈₋₁₀ fatty alcohol + 1PO + 22EO-2-hydroxydecyl ether
HME II: branched C₁₀ fatty alcohol + 22EO-2-hydroxydecyl ether
HME III: linear C₈₋₁₀ fatty alcohol + 40EO-2-hydroxydodecyl ether
LABS: linear alkyl benzenesulfonate, sodium dodecyl benzenesulfonate (MARANIL ® A 55 Cognis)
FAS: C₁₂₋₁₄ fatty alcohol sulfate, SULFOPON ® 1214G (Cognis)
FAES: fatty alcohol ether sulfate, sodium lauryl ether sulfate + 2EO, TEXAPON ® N 70 (Cognis)
SAS: secondary C₁₃₋₁₇ alkane sulfonate, HOSTAPUR ® SAS 60

TABLE 3

| | [% by weight] | | | | |
|---|---|---|---|---|---|
| | C1 | C2 | 1 | 2 | 3 |
| STPP (sodium tripolyphosphate) | 35 | 35 | 35 | 35 | 35 |
| Sodium carbonate (anhydrous) | 7 | 7 | 7 | 7 | 7 |
| Na silicate, amorphous (SiO₂:Na₂O = 2) | 20 | 20 | 20 | 20 | 20 |
| Protease/amylase | 1.8 | 1.8 | 1.8 | 1.8 | 1.8 |
| Na perborate monohydrate/tetrahydrate | 8 | 8 | 8 | 8 | 8 |
| DEHYPON ® LS 54 (fatty alcohol | 10 | — | — | — | — |
| polyglycol ether) | | | | | |
| HME I | — | 10 | 8 | | |
| HME II | | | | 8 | |
| HME III | | | | | 8 |
| FAS | — | — | 2 | 2 | 2 |
| TAED | 3 | 3 | 3 | 3 | 3 |
| Ethane-1-hydroxy-1, 1-diphosphonic acid | 2 | 2 | 2 | 2 | 2 |
| (HEDP) | | | | | |
| Paraffin/emulsifier | 10 | 8 | 10 | 10 | 10 |
| Polyacrylic acid (MW = 8,000) | 2 | 2 | 2 | 2 | 2 |
| Sodium sulfate | to 100 | to 100 | to 100 | to 100 | to 100 |
| Evaluation of shine | | | | | |
| China | 4.4 | 4.0 | 2.4 | 2.0 | 2.2 |
| Glass | 4.2 | 3.4 | 2.0 | 2.6 | 2.8 |
| Cutlery | 4.2 | 3.2 | 2.4 | 2.4 | 2.8 |
| Polypropylene | 4.8 | 3.8 | 2.2 | 2.0 | 2.2 |

Abbreviation in Tables 2-5:
HME I: linear C₈₋₁₀ fatty alcohol + 1PO + 22EO-2-hydroxydecyl ether
HME II: branched C₁₀ fatty alcohol + 22EO-2-hydroxydecyl ether
HME III: linear C₈₋₁₀ fatty alcohol + 40EO-2-hydroxydodecyl ether
LABS: linear alkyl benzenesulfonate, sodium dodecyl benzenesulfonate (MARANIL ® A 55 Cognis)
FAS: C₁₂₋₁₄ fatty alcohol sulfate, SULFOPON ® 1214G (Cognis)
FAES: fatty alcohol ether sulfate, sodium lauryl ether sulfate + 2EO, TEXAPON ® N 70 (Cognis)
SAS: secondary C₁₃₋₁₇ alkane sulfonate, HOSTAPUR ® SAS 60

TABLE 4

| | [% by weight] | | | | |
|---|---|---|---|---|---|
| | C1 | C2 | 1 | 2 | 3 |
| Sodium citrate | 35 | 35 | 35 | 35 | 35 |
| Sodium carbonate (anhydrous) | 7 | 7 | 7 | 7 | 7 |
| Sodium hydrogen carbonate | 10 | 10 | 10 | 10 | 10 |
| Na silicate, amorphous (SiO₂:Na₂O = 2) | 10 | 10 | 10 | 10 | 10 |
| Protease/amylase | 1.8 | 1.8 | 1.8 | 1.8 | 1.8 |
| Na perborate monohydrate/tetrahydrate | 10 | 10 | 10 | 10 | 10 |
| DEHYPON ® LS 54 (fatty alcohol | 10 | — | — | — | — |
| polyglycol ether) | | | | | |
| HME I | — | 10 | 8 | | |
| HME II | | | | 8 | |
| HME III | | | | | 8 |
| FAES | — | — | 2.9 | 2.9 | 2.9 |
| TAED | 3 | 3 | 3 | 3 | 3 |
| Ethane-1-hydroxy-1, 1-diphosphonic acid | 2 | 2 | 2 | 2 | 2 |
| (HEDP) | | | | | |
| Polyacrylic acid (MW = 8,000) | 8 | 8 | 8 | 8 | 8 |
| Sodium sulfate | to 100 | to 100 | to 100 | to 100 | to 100 |
| Evaluation of shine | | | | | |
| China | 5 | 3.2 | 2 | 2.2 | 2.6 |
| Glass | 5 | 3.8 | 1.6 | 2 | 2.6 |
| Cutlery | 4.8 | 3 | 2.2 | 2.4 | 2.6 |
| Polypropylene | 5 | 3.8 | 2 | 2.4 | 1.8 |

Abbreviations in Tables 2-5:
HME I: linear C₈₋₁₀ fatty alcohol + 1PO + 22EO-2-hydroxydecyl ether
HME II: branched C₁₀ fatty alcohol + 22EO-2-hydroxydecyl ether
HME III: linear C₈₋₁₀ fatty alcohol + 40EO-2-hydroxydodecyl ether
LABS: linear alkyl benzenesulfonate, sodium dodecyl benzenesulfonate (MARANIL ® A 55 Cognis)
FAS: C₁₂₋₁₄ fatty alcohol sulfate, SULFOPON ® 1214G (Cognis)
FAES: fatty alcohol ether sulfate, sodium lauryl ether sulfate + 2EO, TEXAPON ® N 70 (Cognis)
SAS: secondary C₁₃₋₁₇ alkane sulfonate, HOSTAPUR ® SAS 60

TABLE 5

| | [% by weight] | | | | |
|---|---|---|---|---|---|
| | C1 | C2 | 1 | 2 | 3 |
| STPP (sodium tripolyphosphate) | 35 | 35 | 35 | 35 | 35 |
| Sodium carbonate (anhydrous) | 20 | 20 | 20 | 20 | 20 |
| Na silicate, amorphous | 10 | 10 | 10 | 10 | 10 |
| (SiO₂:Na₂O = 2) | | | | | |
| Protease/amylase | 1.8 | 1.8 | 1.8 | 1.8 | 1.8 |
| Na perborate monohydrate/ | 8 | 8 | 8 | 8 | 8 |
| tetrahydrate | | | | | |
| DEHYPON ® LS 54 (fatty alcohol | 10 | — | — | — | — |
| polyglycol ether) | | | | | |
| HME I | — | 10 | 8 | | |
| HME II | | | | 8 | |
| HME III | | | | | 8 |
| SAS | — | — | 3.3 | 3.3 | 3.3 |
| TAED | 3 | 3 | 3 | 3 | 3 |
| Ethane-1-hydroxy-1, 1-diphosphonic | 2 | 2 | 2 | 2 | 2 |
| acid (HEDP) | | | | | |
| Polyacrylic acid (MW = 8,000) | 2 | 2 | 2 | 2 | 2 |
| Sodium sulfate | to 100 | | | | |
| Evaluation of shine | | | | | |
| China | 5 | 3.6 | 1.6 | 2.4 | 2.4 |
| Glass | 5 | 3.6 | 2.8 | 2.2 | 2.4 |
| Cutlery | 5 | 3.6 | 1.8 | 2.0 | 2.6 |
| Polypropylene | 5 | 4 | 2.4 | 2.4 | 1.2 |

Abbreviations in Tables 2-5:
HME I: linear C₈₋₁₀ fatty alcohol + 1PO + 22EO-2-hydroxydecyl ether
HME II: branched C₁₀ fatty alcohol +22EO-2-hydroxydecyl ether
HME III: linear C₈₋₁₀ fatty alcohol + 40EO-2-hydroxydodecyl ether
LABS: linear alkyl benzenesulfonate, sodium dodecyl benzenesulfonate (MARANIL ® A 55 Cognis)
FAS: C₁₂₋₁₄ fatty alcohol sulfate, SULFOPON ® 1214G (Cognis)
FAES: fatty alcohol ether sulfate, sodium lauryl ether sulfate + 2EO, TEXAPON ® N 70 (Cognis)
SAS: secondary C₁₃₋₁₇ alkane sulfonate, HOSTAPUR ® SAS 60

What is claimed is:

1. A dishwashing and cleaning composition comprising: (a) from about 0.01 to about 25% by weight of a hydroxy mixed ether of the formula (I):
R¹O[CH₂CHR⁴O]ₓ[CH₂CHR³O]_{y}CH₂CH(OH)R² (I)
wherein each of R¹ and R² is independently an alkyl and/or alkenyl group having from 4 to 22 carbon atoms, each of R³ and R⁴ is independently hydrogen or a methyl group, each of x and y independently has a value of from 0 to 40, with the proviso that x+y≧1; (b) from about 0.1 to about 20% by weight of an anionic surfactant selected from the group consisting of an alkyl and/or alkenyl sulfate, an alkyl ether sulfate, an alkyl benzene sulfonate and an alkane sulfonate.

2. The composition of claim 1 further comprising a nonionic surfactant selected from the group consisting of an alkyl and/or alkenyl polyglucoside, an alkoxylate of an alkanol, an end-capped alkoxylate of an alkanol having no free OH groups, an alkoxylated fatty acid lower alkyl ester and an amine oxide.

3. The composition of claim 2 wherein the alkyl and/or alkenyl polyglucoside is an alkyl and/or alkenyl oligoglycoside.

4. The composition of claim 2 wherein the amount of the nonionic surfactants is from about 0.1 to about 15% by weight.

5. A method for cleaning a hard surface comprising contacting the hard surface with a composition of claim 1.
